(19) United States
(12) Patent Application Publication
(10) Pub. No.: US 2021/0362789 A1
(43) Pub. Date: Nov. 25, 2021

(54) SYSTEM FOR REDUCING THE DRAG OF A VEHICLE

(71) Applicant: Michel Aguilar, Tolosan (FR)

(72) Inventor: Michel Aguilar, Tolosan (FR)

(21) Appl. No.: 17/049,407

(22) PCT Filed: Jul. 11, 2018
(86) PCT No.: PCT/EP2018/068796

§ 371 Date: Oct. 21, 2020

(30) Foreign Application Priority Data
Jul. 13, 2017 (FR) 1756685

(51) Int. Cl. B62D 35/00; B62D 37/02

(52) U.S. Cl. CPC B62D 35/00; B62D 37/02

(57) ABSTRACT

A system (10) for reducing the drag of a vehicle (20), said system (10) includes: a pressurised-gas generator (11) configured to generate a gas stream in a gas distribution circuit (12), a blowing nozzle (13) connected to the gas distribution circuit (12) and configured to eject a gas stream, a blind cavity (14) adjacent to the blast nozzle (13), the cavity (14) and the nozzle (13) being configured such that the ejection of the gas stream by the blast nozzle (13) produces a vortex flow in the cavity (14), resulting in pressures of substantially different intensities being applied to two opposite walls of the cavity (14).

### CROSS REFERENCE TO RELATED APPLICATION

This application is a national stage entry of PCT/EP2018/068796 filed Jul. 11, 2018, under the International Convention and claiming priority over French Patent Application No. 1756685 filed Jul. 13, 2017.

### FIELD OF THE INVENTION

The invention relates to devices permitting the reduction of the aerodynamic or hydrodynamic resistance to the advance of a vehicle and more particularly relates to a system for reducing the drag of a vehicle.

### PRIOR ART

The reduction of the aerodynamic or hydrodynamic resistance to the advance of vehicles, called “drag” in the remainder of the text, has been a subject of research for many years.

The drag of a moving vehicle is generated, in particular, by two physical phenomena: the first lies in the increase in the pressure at the front of the vehicle creating a resistance to advance, and the second lies in a partial vacuum caused by low pressure generated by the vehicle after its passage, resulting in the vehicle being suctioned in a direction opposing its advance. This second phenomenon is known by the term “base drag”

When a vehicle moves the portion of energy consumed in order to overcome the drag is greater if the speed of the vehicle is high. More specifically, the energy used in order to overcome the drag is dependent on its speed squared. The drag thus influences the fuel consumption of the vehicle. Moreover, the greater the drag the lower the maximum speed of the vehicle. At equal power, therefore, the drag has the effect of limiting the maximum speed.

Solutions have been developed to reduce the drag in order to remedy the aforementioned drawbacks.

In particular, the shape of the front wall of the vehicles, whether in the land, maritime or air field, i.e. the face of the vehicle via which it penetrates the fluid (called the frontal area, and more specifically the product of the maximum front surface and the coefficient of drag known by the person skilled in the art), for example the air or water in which it is displaced, is optimized such that it provides the least possible resistance to advance.

Further solutions which are known from the prior art are found in fixed or mobile bodywork panels and parts integrated on the vehicles. In particular, the use of deflectors at the rear of the vehicle is known, i.e. opposing the direction of advance, in order to limit the low pressure formed at the rear of the vehicle.

However, these solutions enable the drag generated by a moving vehicle to be reduced only to a limited degree.

The reduction of the drag may also cause a reduction of the ground contact of the vehicle in the case of motor vehicles.

Specific bodywork panels or parts, for example spoilers, arranged at the rear of vehicles are thus also configured to generate a component having the effect of increasing the ground contact of the vehicle which, as a result, produces a strong additional drag.

### SUMMARY OF THE INVENTION

The object of the present invention is to remedy the aforementioned drawbacks by proposing a system for reducing the drag of a vehicle, making it possible to improve significantly the penetration of the vehicle in a fluid by reducing substantially or by eliminating the aerodynamic or hydrodynamic resistance to advance.

To this end, the present invention relates to a system for reducing the drag of a vehicle, said system having:

a pressurized-gas generator configured to generate a gas stream in a gas distribution circuit,

a blowing nozzle connected to the gas distribution circuit and configured to eject said gas stream,

a blind cavity adjacent to the blowing nozzle,

said cavity and said nozzle being configured such that the ejection of the gas stream by the blowing nozzle produces a vortex flow in the cavity, resulting in pressures of substantially different intensities being applied to at least two opposite walls of the cavity.

Due to these features, during the ejection of the gas stream by the blowing nozzle, the molecules of fluid present in the cavity are entrained by the viscosity of the gas stream to the outside of said cavity, thus generating a localized vortex flow and low pressure in said cavity. Since the vortex flow in the cavity results in pressures of substantially different intensities being applied to at least two opposite walls of the cavity, a resultant force is produced and this has the result of contributing to the reduction of the drag of the vehicle.

The cavity has the effect of contributing to the continuous generation and maintenance of the vortex flow throughout the ejection of the gas by the ejection nozzle and thus of maximizing the effects of the system.

By way of example, the ejected gas is air and the vehicle is a motor vehicle.

Moreover, the reduction of the effective drag is also due to the fact that the gas stream ejected by the blowing nozzle behaves in the manner of an aerodynamic shield on which a relative fluid stream, for example a relative air stream, created by the advance of the vehicle is diverted without said relative air stream physically colliding with the front wall of said vehicle.

Moreover, when the vehicle moves, the ejected gas stream is designed to progress along the vehicle in a direction substantially parallel to a longitudinal axis of said vehicle and in a direction opposing the advance of the vehicle, as far as the rear of the vehicle. The gas stream thus has the effect of significantly reducing the low pressure generated at the rear of the vehicle during the movement thereof. In certain conditions, the pressure of the fluid exerted at the rear of the vehicle may be greater than the pressure of the fluid exerted at the front of the vehicle and thus contribute to the propulsion of the vehicle.

These technical effects lead to a significant saving of the energy required for the movement of the vehicle, and a gain in the stability of the vehicle and the manoeuvrability since the resistance to the penetration in the fluid is significantly reduced thereby.

In particular embodiments, the invention further fulfils the following features, implemented separately or in each of their technically effective combinations.

In particular embodiments of the invention, the cavity includes:

a longitudinal wall designed to oppose a portion of a front wall of the vehicle,

two lateral walls opposing one another, the longitudinal wall being interposed therebetween,

an opening opposing a bottom wall,

the vortex flow being designed to generate the application of a greater pressure on the longitudinal wall than on the portion of the front wall of the vehicle.

In particular embodiments of the invention, the longitudinal wall comprises ribs extending toward the interior of the cavity so as to promote the increase in the intensity of the pressure applied to said longitudinal wall.

This feature makes it possible to increase the technical effects of the present invention.

In particular embodiments of the invention, the cavity is configured to extend in terms of length along a longitudinal axis substantially parallel to a transverse axis of the vehicle and to extend in terms of width along a transverse axis substantially perpendicular to said longitudinal axis, said system comprising means for the displacement of the longitudinal wall which are capable of changing the width of said cavity.

In other words, the means for the displacement of the longitudinal wall are designed to change the distance between the longitudinal wall and the front wall of the vehicle and thus the volume of the cavity.

In particular embodiments of the invention, the distribution circuit is configured to be integrated in at least two walls of the cavity.

These walls may be, in particular, the bottom wall and the longitudinal wall.

In particular embodiments of the invention, the system comprises a deflector which is connected to the blowing nozzle and which is configured to divert a relative fluid stream generated by the displacement of the vehicle toward the blowing nozzle such that said relative stream is diverted by the ejected gas stream.

This feature makes it possible to improve further the effects of the present invention.

In particular embodiments of the invention, the system comprises means for adjusting the speed at which the gas stream is ejected.

This feature makes it possible to be able to adapt the ejection speed of the gas in order to optimize the low pressure generated in the cavity in addition to the dimension of the aerodynamic shield.

In particular embodiments of the invention, the system comprises means for the orientation of the blowing nozzle which are configured to change an ejection angle α of the gas stream via the blowing nozzle by pivoting said blowing nozzle along an axis of rotation substantially parallel to the longitudinal wall of the cavity, the angle α being defined between the direction of ejection of the gas stream and a vertical plane.

This feature makes it possible to change the ejection angle of the gas in order to optimize the reduction of the drag.

In particular embodiments of the invention, the system comprises a control-command member which is designed to be connected to means for determining the speed of a relative fluid stream generated by the movement of the vehicle, said control-command member being configured to vary at least one parameter selected from the speed at which the gas stream is ejected by the blowing nozzle, the width of the cavity, and the ejection angle α of the gas stream via said nozzle, as a function of the determined speed of the relative stream, or a combination of a plurality of these parameters.

The optimization of the reduction of the drag is thus implemented automatically as a function of the speed of advance of the vehicle.

In particular embodiments of the invention, the control-command member is configured such that when the speed of the relative stream is less than a predetermined value, it controls the means for adjusting the ejection speed of the gas such that the ejection speed of the gas is zero.

This feature helps to save the energy generated by the vehicle for the movement thereof.

In particular embodiments of the invention, the control-command member is configured such that when the speed of the relative stream is less than a predetermined value, it controls the means for the displacement of the longitudinal wall so as to retract the nozzle into the vehicle.

For example, the means for the displacement of the longitudinal wall are controlled such that the system is integrated in the front wall of the vehicle. Thus when the vehicle is moving forward at a slow speed, for example below a few kilometres per hour, the cavity does not disrupt the flow of the relative stream along the front wall of said vehicle.

In particular embodiments of the invention, the pressurized-gas generator is configured to be integrated in on-board equipment utilized for running the vehicle, said pressurized-gas generator using the resources thereof.

A further subject of the present invention relates to a vehicle comprising a system for reducing the drag as described above.

### DESCRIPTION OF THE FIGURES

The invention will be understood more clearly by reading the following description, given by way of non-limiting example and made with reference to the figures, in which:

FIG. 1: shows a schematic perspective view of a system for reducing the drag of a vehicle according to the invention,

FIG. 2: shows a schematic side view of a vehicle comprising a system according to FIG. 1.

In these figures reference numerals which are identical from one figure to another denote elements which are identical or similar. Moreover, for reasons of clarity, the drawings are not to scale unless indicated otherwise.

### DETAILED DESCRIPTION OF THE INVENTION

The present invention relates to a system 10 for reducing the drag of a vehicle 20.

The drag is defined in the remainder of the text as the aerodynamic or hydrodynamic resistance to the advance of the vehicle 20 in motion in a fluid.

It should be noted that in the remainder of the text the invention is described in an exemplary embodiment applied to a motor vehicle, the fluid being air.

In the remainder of the text the front of the vehicle 20 is defined as being the part by which it penetrates the air and the rear of the vehicle 20 is defined as being the part opposite the front part of the vehicle 20.

Moreover, in the remainder of the text a horizontal plane is defined by a plurality of points representing the contacts between each tyre of the vehicle 20 with the ground, a vertical plane being perpendicular to said horizontal plane.

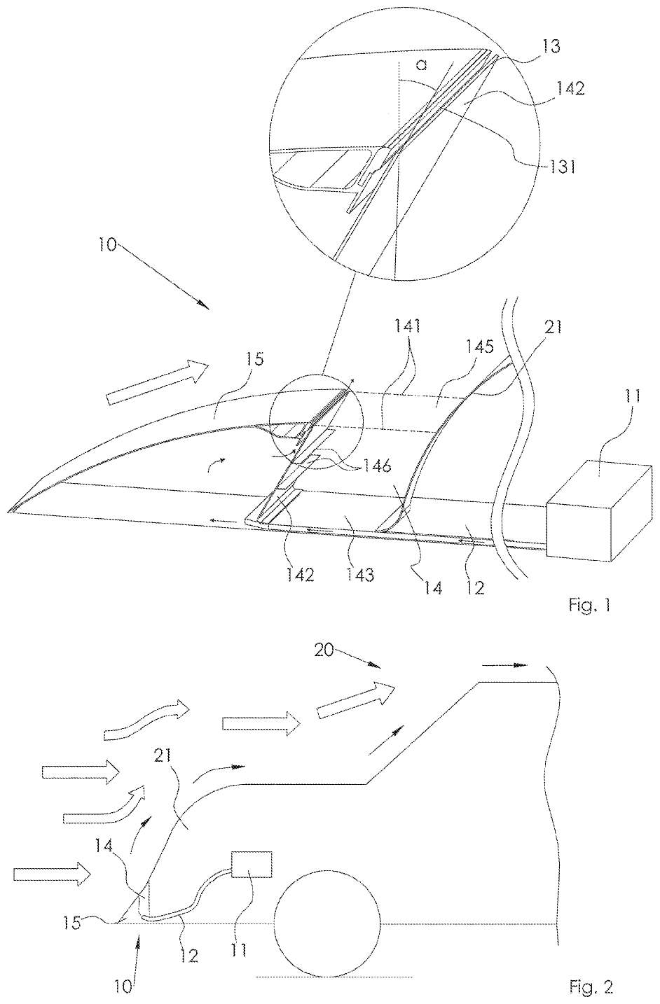

The system 10 for reducing the drag of a vehicle 20 comprises, as shown in FIG. 1, a pressurized-gas generator 11 which is configured to generate a gas stream in a gas distribution circuit 12.

The pressurized-gas generator 11 may be a mechanical compressor known per se by the person skilled in the art, provided to compress a gas, for example air, to a pressure which is equal to two bar.

In an embodiment of the invention, the pressurized-gas generator 11 is designed to be arranged in the vicinity of a propulsion member of the vehicle 20, for example an engine.

Advantageously, the pressurized-gas generator 11 may be designed to be integrated in the on-board equipment utilized for running the vehicle 20, said pressurized-gas generator using the resources thereof. An example of on-board equipment may be a turbocharge system which is activated, for example, by the exhaust gases of the engine of the vehicle 20 in the manner known by the person skilled in the art.

The gas distribution circuit 12 leads to at least one blowing nozzle 13 which is configured to eject the pressurized-gas. The nozzle 13 is designed to be arranged in the vicinity of a front wall 21 of the vehicle 20.

The blowing nozzle 13 comprises an ejection slot 131 via which the pressurized gas is ejected. This ejection slot 131 is preferably designed to extend along a longitudinal axis substantially parallel to a transverse axis of the vehicle 20. By way of information, the slot 131 may extend over approximately one metre and may have a width of approximately several millimetres to approximately one centimetre. Alternatively, the slot 131 is designed to extend from one side of the vehicle 20 to the other.

Preferably, the blowing nozzle 13 is configured such that the direction of ejection of the gas, represented by a thin arrow in FIG. 1, does not intersect the front wall 21 of the vehicle 20.

The blowing nozzle 13 is configured to eject a gas stream at a predetermined speed and at a predetermined angle α, the angle α being defined between the direction of ejection of the gas via the blowing nozzle 13 and a vertical plane parallel to the longitudinal axis of the ejection slot. The ejected gas stream is shown by narrow arrows in FIGS. 1 and 2.

The ejected gas stream is designed to divert a relative fluid stream generated by the displacement of the vehicle 20. This relative fluid stream, called hereinafter “relative stream”, is known by the person skilled in the art by the term “relative wind”. The speed of the relative stream is a function of the speed of the vehicle 20 and is shown by the thick arrows in FIGS. 1 and 2. In the present text, for reasons of simplicity and clarity the “real wind” is considered as insignificant and thus the concept of “apparent wind”, also known by the person skilled in the art, is not discussed here.

By way of information, the gas may be ejected from the ejection slot 131 up to a speed of several hundred metres per second, for example between one hundred and fifty and two hundred and fifty metres per second.

The value of the angle α and the ejection speed of the gas are such that the ejection of the gas stream produces a resultant force increasing the overall propulsive force of the vehicle.

The system 10 for reducing drag according to the invention comprises a blind cavity 14 adjacent to the blowing nozzle 13 and preferably extending entirely along the blowing nozzle 13.

As FIGS. 1 and 2 show, the cavity 14 comprises a longitudinal wall 142 which is designed to oppose a portion of a front wall 21 of the vehicle, two lateral walls 141 opposing one another, the longitudinal wall 142 being interposed therebetween, and an opening 145 opposing a bottom wall 143.

The cavity 14 and the nozzle 13 are configured such that the ejection of the gas stream by the blowing nozzle 13 produces a vortex flow in the cavity 14. The vortex flow has the effect of generating, on the one hand, a low pressure in the cavity and, on the other hand, the application of pressures of substantially different intensities onto at least two opposing walls of the cavity.

The vortex flow is preferably designed to generate the application of a greater pressure on the longitudinal wall 142 than on the portion of the front wall 21 of the vehicle.

The longitudinal wall 142 may comprise ribs 146 which are arranged so as to promote the increase in intensity of the pressure applied to said longitudinal wall 142. Preferably, these ribs 146 are formed by thin pieces rigidly fixed to the longitudinal wall 142 so that they extend along a plane substantially parallel to a horizontal plane, toward the interior of the cavity 14 as shown by FIG. 1.

As FIG. 1 shows, the distribution circuit 12 is configured to be integrated in at least two walls of the cavity 14. These walls are preferably the bottom wall and the longitudinal wall.

The periphery of the opening 145 is defined by a portion of the front wall 21 and by the ends of the lateral walls 141 and the longitudinal wall 142. The opening 145 is represented by thick dashed lines in FIG. 1.

The cavity 14 is designed to extend in terms of length along a longitudinal axis substantially parallel to a transverse axis of the vehicle 20 and to extend in terms of width along a transverse axis substantially perpendicular to said longitudinal axis.

The system 10 according to the invention advantageously comprises means for the displacement of the longitudinal wall 142 which are capable of changing the width of said cavity 14, and as a result, the width of the opening 145.

When the longitudinal wall 142 is displaced in translation, the dimensions of the opening 145 of the cavity 14 and the volume defined by the cavity 14 are changed. In the direction of displacement of the longitudinal wall 142, the opening 145 may be reduced until it is sealed, or may be widened, for example up to approximately fifteen centimetres.

Alternatively, in a further embodiment, the longitudinal wall 142 may be retracted so as to be integrated in the bodywork of the vehicle, for example by means of a hinge, not shown in the figures.

Advantageously the blowing nozzle 13 opens out from the longitudinal wall 142, preferably in the region of the opening 145 of the cavity 14.

The lateral walls 141 may extend beyond the blowing nozzle 13, by their ends defining the opening 145, in order to define a guide corridor for the ejected gas stream.

Due to the features described above, during the ejection of the gas stream by the blowing nozzle 13, the molecules of air present in the cavity 14 are entrained by the viscosity of the gas stream to the outside of said cavity 14, generating the aforementioned localized vortex flow and low pressure in said cavity 14. This vortex flow, in particular, has the effect of causing a significant reduction in pressure on at least one portion of the front wall 21 and an increase in pressure on the longitudinal wall 142, thus creating a resultant force contributing to the advance of the vehicle.

Moreover, the ejected gas stream is designed to progress along the bodywork of the vehicle 20 in a direction substantially parallel to a longitudinal axis of said vehicle 20, as far as the rear of the vehicle 20. The gas stream thus has the effect of significantly reducing the low pressure of the fluid generated at the rear of the vehicle 20.

A further technical effect generated by the ejection of the fluid is the increase in the contact of the vehicle 20 with the ground, due to the generation of a normal force relative to the ground by the ejection of the gas.

In order to change the angle α, the blowing nozzle 13 may be mobile about an axis of rotation extending substantially parallel to the longitudinal wall 142 of the cavity 14. In other words, the axis of rotation extends substantially transversely to the vehicle 20. Moreover, the system 10 for reducing the drag comprises means for the orientation of the blowing nozzle 13 in order to change the angle α. For example, the angle α may have a value ranging between ten and forty degrees.

In one embodiment, the means for the orientation of the blowing nozzle 13 displace a portion of the distribution circuit 12 in translation in order to pivot the blowing nozzle 13, a flexible connection interposed between the distribution circuit 12 and the blowing nozzle 13 permitting the transformation of the translatory movement into a rotational movement.

The ejection speed of the pressurized gas may be changed by the means for adjusting the ejection speed of the gas, for example by changing the compression ratio of the gas by acting on the pressurized-gas generator 11 for the gas.

For example, the flow rate of the pressurized gas, which is generated by the turbocharger and which is designed to be ejected by the ejection nozzle 13, may be adjusted by means for changing the section of the conduit 12. Said means are advantageously capable of changing the section of the conduit 12 between a first extreme position in which said section is zero in order to close the conduit 12, and a second extreme position in which said section has a maximum value in order to open the conduit 12.

The system 10 for reducing drag may comprise a deflector 15 which is connected to the blowing nozzle 13 and which is configured to orientate the flow of the relative stream to the blowing nozzle 13 so that said relative stream is diverted by the ejected gas stream.

This deflector 15 may advantageously have a cross section of convex shape as FIG. 1 shows.

Moreover, in an embodiment of the invention shown by FIG. 1, the deflector 15 may create a volume capable of forming a gas reservoir supplied with gas from the gas distribution circuit. This reservoir is advantageously in communication with the nozzle so that as long as said reservoir is supplied with gas, the nozzle ejects a continuous gas stream. In this embodiment, a flexible connection is not interposed between the distribution circuit 12 and the blowing nozzle 13.

The deflector 15 is mobile in translation relative to the front wall 21 so that the means for the displacement of the longitudinal blowing wall 142, when said means displace said blowing nozzle 13, also change the position of the deflector 15 relative to the front wall 21 of the vehicle 20. For example, the deflector 15 slides into abutment against the front wall 21 during the sealing of the opening 145. Conversely, the deflector 15 slides away from the front wall 21 during the widening of the opening 145.

Alternatively, in a further embodiment, in a similar manner to the nozzle, the deflector may be retracted so as to be integrated in the bodywork of the vehicle, for example by means of a hinge, not shown in the figures.

Advantageously, the system 10 according to the invention comprises a control-command member designed to be connected to the means for determining the speed of the relative stream.

The control-command member may be configured to vary at least one parameter selected from the speed at which the gas stream is ejected by the blowing nozzle 13, the width of the cavity 14, and the ejection angle α of the gas stream via said nozzle 13 as a function of the determined speed of the relative stream. Alternatively, the control-command member may be configured to vary a combination of a plurality of these parameters.

To this end, the control-command member is capable of controlling the means for the orientation of the blowing nozzle 13, the means for adjusting the ejection speed of the gas and the means for the displacement of the longitudinal wall 142.

These means for determining the speed of the relative stream may be members for measuring the speed of the vehicle 20 or members for measuring the speed of the relative stream.

For example, the control-command member is configured so that when the speed of the relative stream is less than a predetermined value, for example approximately one or or a few metres per second, the means for adjusting the ejection speed are controlled so that the ejection speed of the gas is zero. Moreover, the means for the displacement of the longitudinal blowing wall 142 may be controlled such that the distance between the blowing nozzle 13 and the front wall 21 is zero, i.e. the blowing nozzle 13 is in contact with the front wall 21 so as to seal the opening 145. Alternatively, the means for the displacement of the longitudinal blowing wall 142 may be controlled so as to retract the blowing nozzle 13 and the deflector 15.

Beyond the predetermined value, the means for adjusting the ejection speed are controlled so that the ejection speed of the gas reaches a predetermined value, the means for the orientation of the nozzle are controlled so that the angle α has a predetermined value, and the means for the displacement of the longitudinal blowing wall 142 are controlled so that the distance between the blowing nozzle 13 and the front wall 21 reaches a predetermined value, so that the reduction of the drag is optimized for a given speed of the relative stream.

In a more general manner, it should be noted that the methods for implementation and the embodiments considered above have been described by way of non-limiting examples, and thus other variants are conceivable.

In particular, the invention has been principally described by considering a motor vehicle. However, there is nothing to preclude, according to other examples, considering other types of vehicle, such as aircraft, railway vehicles or naval vessels. Moreover, the system according to the invention may comprise a plurality of cavities 14 juxtaposed with one another, and as many blowing nozzles, arranged in a manner similar to that described above.

1. A system (10) for reducing the drag of a vehicle (20), said system (10) comprising:
a pressurized-gas generator (11) configured to generate a gas stream in a gas distribution circuit (12),
a blowing nozzle (13) connected to the gas distribution circuit (12) and configured to eject said gas stream,
a blind cavity (14) adjacent to the blowing nozzle (13),
said cavity (14) and said nozzle (13) being configured such that the ejection of the gas stream by the blowing nozzle (13) produces a vortex flow in the cavity (14), resulting in pressures of substantially different intensities being applied to at least two opposite walls (21, 142) of the cavity (14).

2. The system (10) according to claim 1, wherein the cavity (14) comprises:
a longitudinal wall (142) designed to oppose a portion of a front wall (21) of the vehicle,
two lateral walls (141) opposing one another, the longitudinal wall (142) being interposed therebetween,
an opening (145) opposing a bottom wall (143),
the vortex flow being designed to generate the application of a greater pressure on the longitudinal wall (142) than on the portion of the front wall (21) of the vehicle.

3. The system (10) according to claim 2, wherein the longitudinal wall (142) comprises ribs (146) extending toward the interior of the cavity (14) so as to promote the increase in the intensity of the pressure applied to said longitudinal wall (142).

4. The system (10) according to claim 2, wherein the cavity (14) is configured to extend in terms of length along a longitudinal axis substantially parallel to a transverse axis of the vehicle (20) and to extend in terms of width along a transverse axis substantially perpendicular to said longitudinal axis, said system (10) comprising a displacement device for displacing the longitudinal wall (142) which are capable of changing the width of said cavity (14).

5. The system (10) according to claim 1, wherein the distribution circuit (12) is configured to be integrated in at least two walls of the cavity (14).

6. The system (10) according to claim 1, further comprising a deflector (15) which is connected to the blowing nozzle (13) and which is configured to divert a relative fluid stream generated by the displacement of the vehicle (20) toward the blowing nozzle (13) such that said relative stream is diverted by the ejected gas stream.

7. The system (10) according to claim 1, further comprising an adjusting device to adjust the speed at which the gas stream is ejected.

8. The system (10) according to claim 2, comprising an orientation device for the orientation of the blowing nozzle (13) which are configured to change an ejection angle α of the gas stream via the blowing nozzle (13) by pivoting said blowing nozzle (13) along an axis of rotation substantially parallel to the longitudinal wall (142) of the cavity (14), the angle α being defined between the direction of ejection of the gas stream and a vertical plane.

9. The system (10) according to claim 4, further comprising a control-command member which is designed to be connected to a device for determining the speed of a relative fluid stream generated by the displacement of the vehicle (20), said control-command member being configured to vary at least one parameter selected from the speed at which the gas stream is ejected by the blowing nozzle (13), the width of the cavity (14), and the ejection angle α of the gas stream via said nozzle (13), as a function of the determined speed of the relative stream, or a combination of a plurality of these parameters.

10. The system (10) according to claim 9, wherein the control-command member is configured such that when the speed of the relative stream is less than a predetermined value, it controls the adjusting device for the ejection speed of the gas such that the ejection speed of the gas is zero.

11. The system (10) according to claim 9, wherein the control-command member is configured such that when the speed of the relative stream is less than a predetermined value, it controls the displacement device of the longitudinal wall (142) so as to retract the nozzle into the vehicle (20).

12. The system (10) according to claim 1, wherein the pressurized-gas generator (11) is configured to be integrated in on-board equipment utilized for running the vehicle (20), said pressurized-gas generator using the resources thereof.

13. A vehicle (20) comprising the system (10) for reducing the drag according to claim 1.
